(19) United States
(12) Patent Application Publication
(10) Pub. No.: US 2014/0181049 A1
(43) Pub. Date: Jun. 26, 2014

(54) ARCHIVAL SYSTEMS AND METHODS FOR LIVE PERFORMANCES

(71) Applicant: IDEA DEN, Nashville, TN (US)

(72) Inventors: DALE MANNING, Franklin, TN (US); TED BENICE, Roseburg, OR (US)

(73) Assignee: IDEA DEN, Nashville, TN (US)

(21) Appl. No.: 14/134,317

(22) Filed: Dec. 19, 2013

Related U.S. Application Data
(60) Provisional application No. 61/740,036, filed on Dec. 20, 2012.

(51) Int. Cl. G06F 17/30

(52) U.S. Cl. CPC G06F 17/30073
USPC 707/661

(57) ABSTRACT

Method and systems for creating a consumer accessible archive of live performances are described. The consumer accessible archive may be created by receiving a data file including recorded data for a live performance of an artist via a network at a central location, receiving another data file including recorded data for another live performance of the artist via the network at the central location, generating an archive including the recorded data, and posting the archive by the computer server system for access of the first and second portions by consumers via the network. Methods and systems are also described for creating and archiving live performances and for uploading digital content related to a live performance to a computer server system.

### CROSS-REFERENCE TO RELATED APPLICATION

This application claims priority to U.S. Provisional application Ser. No. 61/740,036 entitled ARCHIVAL SYSTEMS AND METHODS FOR LIVE PERFORMANCES, filed on Dec. 20, 2012, the contents of which are Incorporated fully herein by reference.

### BACKGROUND OF THE INVENTION

The purchase of audio/video content (e.g., music and music video data files) over the Internet is extremely popular. Conventional music and video archival sites enable individuals to purchase audio/visual content over the Internet from the comfort of their own home. The audio/video content available from such archival sites are typically produced in audio and/or television studios. This studio-produced content lacks the look and feel of live performances.

Many individuals enjoy attending live performances. Audio/video content from such live performances, however, are not readily available from conventional music and video archival sites.

### SUMMARY OF THE INVENTION

The present invention is embodied in methods and systems for creating a consumer accessible archive of live performances, creating and archiving live performances, and uploading digital content related to a live performance to a computer server system.

A consumer accessible archive of live performances may be created by receiving a first data file including first recorded data for a first live performance of a first artist via a network at a central location, receiving a second data file including second recorded data for a second live performance of the first artist via the network at the central location, generating an archive including at least a first portion of the first recorded data and at least a second portion of the second recorded data by processing the first and second data files with a computer server system, and posting the archive by the computer server system for access of the first and second portions by consumers via the network.

Live performances may be created and archived by generating a digital performance file corresponding to a live performance with a content provider computer system, creating a digital archive with the content provider computer system including a first portion of the live performance and a second portion of the live performance by processing the digital performance file (the first and second portions each associated with metadata uniquely identifying the first and second portions), and uploading the digital archive with the associated metadata from the content provider computer system to a computer server system via a network.

Digital content related to a live performance may be uploaded to a computer server system by generating a digital content file related to a live performance with a consumer computer system, associating the digital content file with metadata using the consumer computer system (the metadata related to the live performance), and uploading the digital content file with the associated metadata from the consumer computer system to a computer server system via a network.

### BRIEF DESCRIPTION OF THE DRAWINGS

The invention is best understood from the following detailed description when read in connection with the accompanying drawings, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be dropped. The letter “n” may represent a non-specific number of elements. Also, lines without arrows connecting components may represent a bi-directional exchange between these components. This emphasizes that according to common practice, the various features of the drawings are not drawn to scale. On the contrary, the dimensions of the various features are arbitrarily expanded or reduced for clarity. Included in the drawings are the following figures:

FIG. 1 is a block diagram of an archival system in accordance with aspects of the present invention;

FIG. 2 is a block diagram of a computer system for use in the archival system of FIG. 1;

FIG. 3 is a flow chart of steps for archiving live performances in a computer server system and fulfilling consumer requests In accordance with aspects of the present invention;

FIG. 4 is a flow chart of steps for capturing live performances and uploading them to a computer server system in accordance with aspects of the present invention; and

FIG. 5 is a flow chart of steps for capturing content associated with live performances and uploading them to a computer server system in accordance with aspects of the present invention.

### DETAILED DESCRIPTION OF THE INVENTION

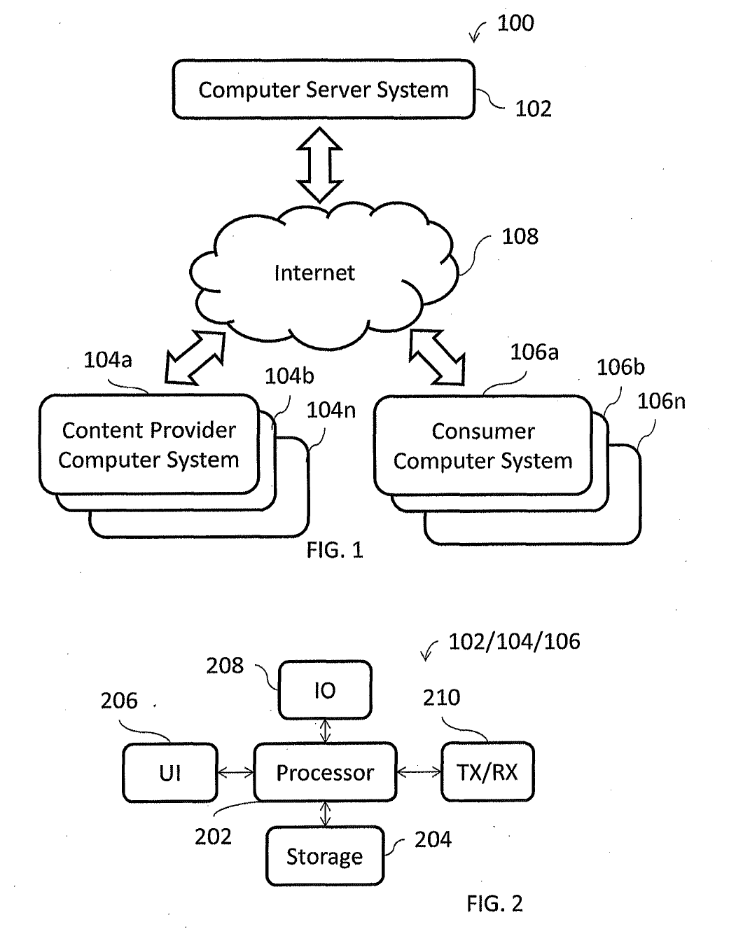

FIG. 1 depicts a system 100 for archiving audio and/or video content from live performances. As used herein, the phrase “live performance” refers to a performance by an artist to a consumer audience (e.g., a concert) and does not include performances by an artist that are recorded without a consumer audience (e.g., a studio recording). The system 100 includes a computer server system 102 that stores the content, a content provider computer system 104 that gathers the content and provides the content to the computer server system 102, and a consumer computer system 106 that retrieves the content from the computer server system. In some embodiments, the consumer computer system 106 may also provide content related to live performances that can be retrieved by other consumer computer systems 106. The computer systems may communicate with each other via a network such as the Internet 108 in the illustrated embodiment.

In an exemplary implementation, the system 100 is a fan engagement system that brings together all of the elements needed for entertainment brands to connect with their customers and fans. Its comprehensive approach offers brands the strongest possible online presence, in one central hub, and the tools to grow their fan base.

FIG. 2 depicts exemplary component of the computer systems 102/104/106 of FIG. 1. Each computer system includes a processor 202 for processing instructions and storage 204 with which the processor 202 communicates. Storage 204 includes instructions for configuring the computer systems when executed by the processor to provide the functionality of its respective computer system. The computer systems additionally include a user interface (UI) 206 that can be employed by a user of a computer system to interact with that computer systems and a transmitter and/or transceiver (TX/RX) for communicating with other computer systems over a network such as the Internet 108 (FIG. 1) in the illustrated embodiment. One or more of the computer systems may include input and/or output devices/ports (IO) 208 for receiving data from an external source (e.g., a microphone or video camera; not shown). Suitable processors 202, storage 204, UI 206, IO 208 and TX/RX 210 will be understood by one of skill in the art from the description herein.

For the computer server system 102, the computer system 106 may be a conventional computer system or collection of conventional systems. In an embodiment where the computer server system 102 is a conventional computer, the processor 202, storage 204, UI 206, IO 208, and TX/RX 210 may be components commonly found in such system. Other suitable computer systems/components for use as the computer system 106 will be understood by one of skill in the art from the description herein. For example, the computer server system 102 may be a distributed system comprising one or more processors 202 and one or more storage components 204.

For the content provider computer system 104, the computer system may be a portable computer system such as a laptop computer. In an embodiment where the content provider computer system 104 is a laptop computer, the processor 202, storage 204, UI 206, IO 208, and TX/RX 210 may be components commonly found in conventional laptop computers. The UI 206 may be a conventional keypad, mouse, touchpad, and/or display, the IO 208 may be a conventional camera and/or microphone, and the TX/RX 210 may be a conventional transceiver such as a cellular transceiver and/or network interface for accessing a network connected to the Internet. The IO 208 may additionally include a port(s) for receiving information from external data sources such as audio and/or video recording equipment, instrument outputs such as musical instrument digital interface (MIDI) outputs, and/or other devices for providing audio and/or video content from a live performance. Software for configuring such systems for use in accordance with the present invention may be downloaded from the computer server system 102 and/or from another site such as the Apple App store maintained by Apple Inc. Other suitable computer systems/components for use as the computer system 104 will be understood by one of skill in the art from the description herein.

For the consumer computer system 106, the computer system 106 may be a home computer system, a portable computer system, or a mobile device such as a cellular telephone (e.g., an iPhone available from Apple, Inc. of Cupertino, Calif.). In an embodiment where the consumer computer system 106 is a cellular telephone, the processor 202, storage 204, UI 206, IO 208, and TX/RX 210 may be components commonly found in a conventional cellular telephone. The UI 206 may be a conventional keypad and/or display, the IO 208 may be a conventional camera and/or microphone, and the TX/RX 210 may be a conventional cellular transceiver and/or network interface for accessing a network connected to the Internet. Software for configuring such systems for use in accordance with the present invention may be downloaded from the computer server system 102 and/or from another site such as the Apple App Store maintained by Apple Inc. Other suitable computer systems/components for use as the computer system 106 will be understood by one of skill in the art from the description herein.

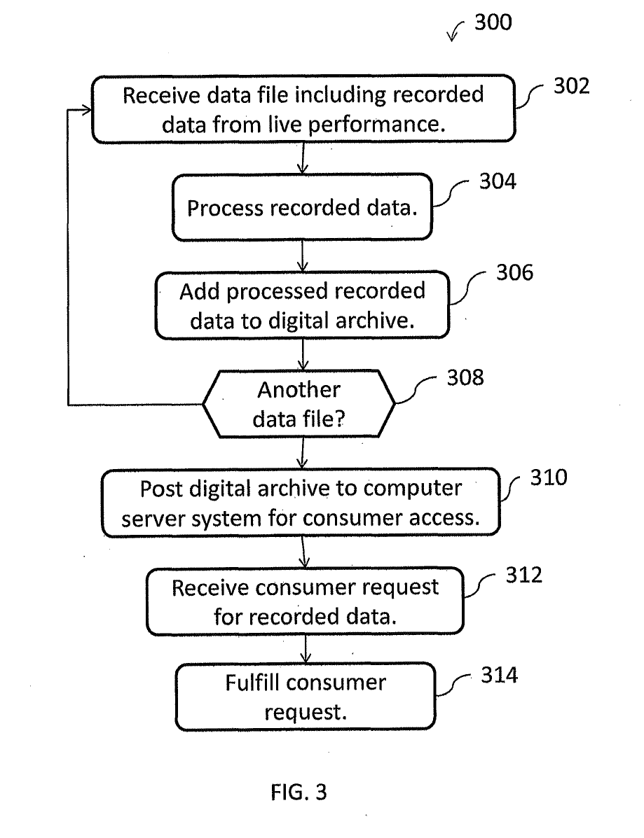

FIG. 3 depicts a flow chart 300 for creating a fan accessible archive of live performances. The steps of flow chart 300 will be described with reference to the computer systems 102/104/106 depicted in FIGS. 1 and 2 to facilitate description. Other computer systems for use with the present invention will be understood by one of skill in the art from the description herein. It will be understood the one or more of the steps may be performed in a different order than as depicted or may be omitted without departing from the spirit and scope of the present invention.

At block 302, a data file including recorded data from a live performance is received. In one embodiment, the data file is received over an network such as the Internet by a computer server system 102. The computer server system 102 may receive the file at a processor 202 via a transceiver 210 from a content provider computer system 104 or a consumer computer system 106. The received data file may including recorded data (audio and/or video) for a live performance of an artist. Additionally, the received data file may include metadata related to the recorded data (e.g., data identifying the artist's name, the start of a new song, date recorded, performance location, song name, live performance title, track length, whether the song is a cover of another artist's song and that artist's name (if applicable), etc.). Subsequent data files may be received for the same artist for another performance. For example, a first data file may be received including recorded data for a first live performance of the artist and a second data file may be received including recorded data for a second live performance of that artist. Additionally, subsequent data files including recorded data may be received for another artist. For example, a third data file including recorded data may be received for a live performance of another artist and a fourth data file including recorded data may be received for another live performance of this other artist.

In addition to recorded data from a live performance, a digital content file including content related to the live performance may be received. In one embodiment, the digital content file is received over a network such as the Internet 108 by the computer server system from a consumer computer system 106. The digital content may include, for example, a photo of the artist or a photo of the crowd captured during the live performance.

At block 304, the recorded data in the received file is processed. In one embodiment, the processor 202 of the computer server system 102 processes the recorded data. The processor 202 may process the recorded data and the metadata to identify individuals songs in the recorded data. The processor 202 may additionally generate multiple versions of the recorded data (e.g., a lossless compression (lossless) audio-only version, a lossy compression (lossy; e.g., mp3) audio-only version, a lossless compression/high definition (HD) audio/video version, and/or a lossy compression/standard definition (SD) audio/video version).

In one embodiment, the recorded data is received in a compressed archive file (e.g., a .zip file). In accordance with this embodiment, the processor 202 may unzip the archive file, scan the song files to eliminate duplicates, generate multiple formats of the song files as noted below, archive the collections of songs in different formats (separate archives), send the files to another computer for storage (amazon s3), generate a shortened version of each song file (˜30 sec) ‘clips’, send the ‘clips’ to another computer for storage (amazon s3), contact server system 102 to send data informing server system 102 that the process is completed.

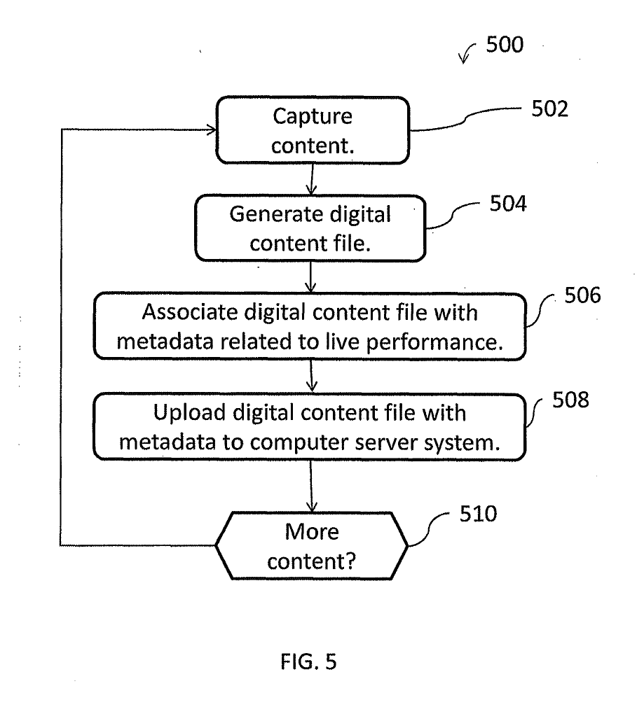

Optionally, related digital content may also be processed by computer server system 102. In one embodiment, the digital content file includes metadata. The metadata is related to the live performance and may be associated with the digital content file as described below with reference to FIG. 5. The computer server system 102 may match the metadata to one of the live performances and post the digital content file for access with the live performance matching the metadata of the digital content file.

At block 306, the processed recorded data is added to a digital archive. In one embodiment, the processor 202 of computer server system 102 adds the processed recorded data (and optionally related digital content) to a digital archive in storage 204. At least a first portion of the recorded data (e.g., audio and/or video related to a song of a live performance) and at least a second portion (e.g., audio and/or video related to another song of the live performance) may be added to the digital archive.

At block 308, a check for another data file is performed to identify an additional data file(s) including recorded data from the live performance. In one embodiment, the processor 202 of the computer server system 102 checks if another data file is present. If an additional data file is present, processing returns to block 302. Otherwise processing proceeds at block 310.

At block 310, the digital archive is posted to a computer server system for consumer access to the recorded data. In one embodiment, processor 202 of the computer server system 102 posts the digital archive to a computer server system such that consumers may access at least portions of the recorded data. The digital archive may be posted by storing the digital archive in a consumer accessible area of storage 204 in computer server system 102. Alternatively, the digital archive may be posted to another computer system (not shown) that is accessible by consumers.

At block 312, a request for recorded data in the digital archive is received from a consumer. In one embodiment, the processor 202 of the computer server system 102 receives the request over the Internet 108 via the transceiver 210. Alternatively, another computer system (not shown) accessible by consumers may receive the request.

At block 314, the consumer request is fulfilled. In one embodiment, the processor 202 of the computer server system 102 processes the received request, identifies recorded data (and optionally related digital content) corresponding to the received request, and provides the identified recorded data (and optionally related digital content) to the consumer in order to fulfill the request. Alternatively, another computer system (not shown) that is accessible by consumers may fulfill the request. In one embodiment, the request may specify audio and/or video and lossless/HD or lossy/SD. In accordance with this embodiment, the content corresponding to the request is identified and provided to the consumer to fulfill the request.

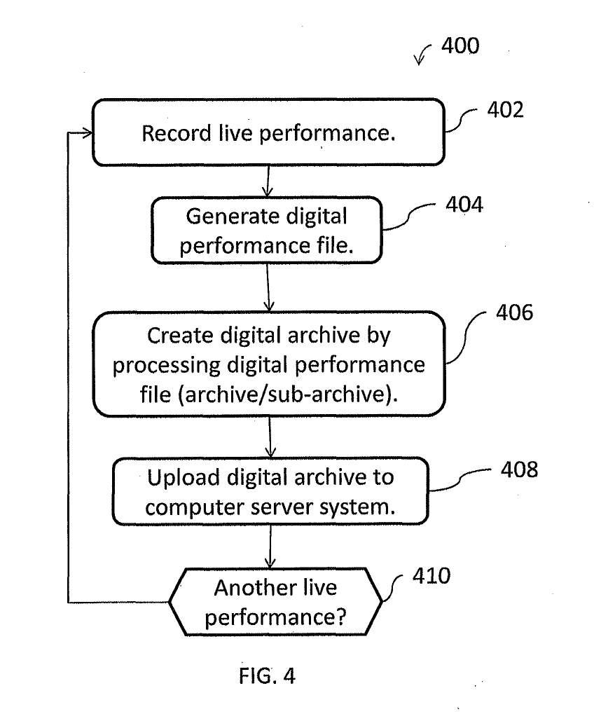

FIG. 4 depicts a flow chart 400 for creating and archiving live performances. The steps of flow chart 400 will be described with reference to the computer systems 102/104/106 depicted in FIGS. 1 and 2 to facilitate description. Other computer systems for use with the present invention will be understood by one of skill in the art from the description herein. It will be understood the one or more of the steps may be performed in a different order than as depicted or may be omitted without departing from the spirit and scope of the present invention.

At block 402, a live performance of an artist is recorded. The live performance includes audio and, optionally, video content. In one embodiment, the processor 202 of the content provider computer system 104 is used to record the live performance. Audio and, optionally, video may be captured via IO 208 of content provider computer system 104 and stored in storage 204. Alternatively, or additionally, audio and/or video may be captured via UI 206 and stored in storage 204.

At block 404, a digital performance file is generated. The digital performance file corresponds to the live performance. The digital performance file may include at least a portion of the live performance and, optionally, metadata related to the live performance. In one embodiment, the processor 202 of the content provide computer system 104 generates the digital performance file.

At block 406, a digital archive of the live performance is created by processing the digital performance file. In one embodiment, the processor 202 of the content provider computer system 104 processes the digital performance file to create the digital archive. The digital archive includes at least a first portion of the live performance (e.g., a song) and a second portion of the live performance (e.g., another song). The first and second portions may each be associated with metadata uniquely identifying the respective portions.

In one embodiment, the content provider computer system 104 may create a first sub archive including the first portion of the live performance and the second portion of the live performance in a first format (e.g., mp3) and second sub archive including a second sub archive including the first portion of the live performance and the second portion of the live performance in a second digital format (e.g., lossless). Enabling the content provider computer system to create sub archives for performances provides greater flexibility to the artist over how their live performance are distributed.

At block 408, the digital archive (which may include sub archives) is uploaded to a computer server system. In one embodiment, the processor 202 of the content provider computer system 104 uploads the digital archive to the computer server system 102 via transceiver 210 and a network such as the Internet 108.

At block 410, a check for another live performance to process is performed. In one embodiment, the processor 202 of the content provider computer system 104 checks for another live performance to process. If an additional live performance is present, processing returns to block 402. Otherwise, processing ends.

FIG. 5 depicts a flow chart 500 for providing audio and/or video captured by a consumer to a computer server system for association with an artist's live performance. The steps of flow chart 500 will be described with reference to the computer systems 102/104/106 depicted in FIGS. 1 and 2 to facilitate description. Other computer systems for use with the present invention will be understood by one of skill in the art from the description herein. It will be understood the one or more of the steps may be performed in a different order than as depicted or may be omitted without departing from the spirit and scope of the present invention.

At block 502, content related to a live performance is captured as a digital content file. In one embodiment, the content is captured by a processor 202 of consumer computer system 106 and stored in storage 204 during the live performance by an artist. The portion may be audio and/or video (still image or moving), e.g., of the artist or the crowd.

At block 504, a digital content file is generated. In one embodiment, processor 202 of the consumer computer system 106 generates the digital content file.

At block 506, the digital content file is associated with metadata. The metadata may identify the artist, performance, song, and may be used by a computer server system to correlate with live performance data. In one embodiment, the processor 202 of consumer computer system 106 associates the metadata with the digital content file. The consumer may be presented with a graphical user interface (GUI) on UI 206 that enables metadata to be associated with the digital content file. For example, the user may be presented with a list of artists and a list of performances. By selected an artist and a performance for a digital file, the artist and performance may be associated as metadata with the digital content file.

In one embodiment, positioning information (e.g., global positioning information (GPS) and/or cellular/Wi-Fi triangulation) and current time information may be used to: 1) pre-populate the GUIs with corresponding artist/performance information for selection by the user; 2) automatically generate the artist/performance metadata and associate it with the digital performance file; or 3) serves as the metadata itself for later identification of the artist/performance, e.g., by the computer server system 102.

At block 508, the digital content file with the associated metadata is uploaded to a computer server system. In one embodiment, the processor 202 of the consumer computer system 106 uploads the digital archive to the computer server system 102 via transceiver 210 and a network such as Internet 108.

At block 510, a check for more live performance content is performed. In one embodiment, the processor 202 of the consumer computer system 106 checks for more content of the live performance to process. If more content is present, processing returns to block 502. Otherwise, processing ends.

Additionally, the processor 202 of the computer server system 102 may implement the following modules:

Base module—this module includes sub-modules that provide features that are shared across the platform. These include, by way of non-limiting example: content fields (e.g., text, image, video-embed, reference fields, etc.); a what you see is what you get (wysiwyg) editor; user roles and permissions; user profiles; a “user bar” that includes some user info and userful links; functionality to add ajax ‘popup’ blocks of content; code to interact with the Facebook graph application programming interface (api), code to manipulate mailchimp email lists via the mailchimp api twitter integration; broadcasting user generated content to social networks; and a ‘user-dashboard’ that aggregates in one place functionality that users may be interested in e.g. their account info, store orders, digital files they have purchased, community activity, messages, activity in community groups that they have signed up to receive, etc.

Ad module—this module provides an interface to create banner advertisements and display them on the site. Also provides a way to display ads on any page that can be dismissed by the user (‘Spotlight’ functionality).

Albums module—this module provides an interface to create full discographies of an artist's work from an archive of tagged mp3 files. It may be used to create albums, songs, and media content that are interconnected to allow a unified display of the work. This module may also provide the code that formats the display of this content.

Analytics module—this module allows the system to send site data to a central repository, and also display some ‘at a glance’ information about aspects of the site such as sales, user data, etc. The central repository may be used to generate reports of various types, e.g. sales reports, brand profile information (data about fans), etc.

Articles module—this module provides an interface for inputting and categorizing news and associated media on the site. Text news stories, video and/or photo data may be stored in articles. This module also provides code that formats display of content. Article content may be aggregated by the gallery module to provide a central display of photos/videos.

Community module—this module provides an interface for site visitors to interact with each other. In one embodiment, there is a site page on which users can see content posted by other users, and a ‘feed’ provided on legacy event pages where users can post and see posts about a particular legacy event. Users can follow other users' posts, get other users' attention by ‘waving’ at them, and send private messages to other users. Users may be kept up-to-date on content that they are interested in via an activity feed that shows new activity (comments/likes) on community posts that they have commented on or liked in the past.

Events module—this module provides an interface for upcoming events and/or past (legacy) events. Upcoming events may be created on the site and automatically pushed to the artist's Facebook page creating a Facebook event. Once the event is in the past, or upon an administrator's command, the event may be converted to a legacy event which has a different display than upcoming events. A user with permissions, on the road with the artist, can use the provided interface to upload a mix of the live music, photos, videos, a set list, and any other information about the show. Users can purchase the live show and download the music. Also, if a user has had a ‘meet & greet’ with the artist (which always involves photos), they can Facebook like their photo and when their Facebook friends follow the link from their Facebook page the meet & greet photo will be featured prominently on the page.

This module may also include functionality that allows users to purchase special privileges on the website. They can get deals in the store, access special content, pre-order tickets or music, and request meet & greets with the artist at their shows. The module provides mechanisms for administering these meet & greets.

Gallery module—this module may pull photos and videos from articles and legacy events into a gallery page. The gallery page tiles these visual content in a pleasing way for users to peruse.

Campaigns module—this module provides an interface for admins to create campaigns that stimulate user activity on the site, e.g., ‘share campaigns’ that allow users to share links to site content that when clicked by others accrue points for the user. These points can lead to special privileges on the site such as discount, roles, marks of status (badges), rank, etc. These campaigns can be executed as contests in which users compete for a prize at the end.

Store module—this module provides an eCommerce engine behind an online store. It may utilize the Drupal ‘commerce’ contributed module as the basis, but expands upon it by: 1) providing a modern user experience with store browsing without leaving the store page, 2) allowing administrators to assign handing fees to products based on categories, allowing administrators to create complex discounts targeting specific products, categories of products, etc., and apply flexible rules to create the discounts, and 4) provides lots of custom administration tools for the store that are not in the contributed module.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method for creating a consumer accessible archive of live performances, the method comprising:
receiving a first data file including first recorded data for a first live performance of a first artist via a network at a central location;
receiving a second data file including second recorded data for a second live performance of the first artist via the network at the central location;
generating an archive including at least a first portion of the first recorded data and at least a second portion of the second recorded data by processing the first and second data files with a computer server system; and
posting the archive by the computer server system for access of the first and second portions by consumers via the network.

2. The method of claim 1, further comprising:
receiving a third data file including third recorded data for a third live performance of a second artist via the network at the central location; and
receiving a fourth data file including fourth recorded data for a fourth live performance of the second artist via the network at the central location;
wherein the archive is generated by further processing the third and fourth recorded data by the computer server system to include at least a third portion of the third recorded data and a fourth portion of the fourth recorded data and the archive is posted for access of the first, second, third, and fourth portions by the consumers via the network.

3. The method of claim 1, further comprising:
receiving a digital content file with metadata;
matching the metadata to one of the first live performance or the second live performance;
posting the digital content file for access with the live performance matched to the metadata of the digital content file.

4. The method of claim 3, wherein the live performance matched to the metadata of the digital content file is the first live performance and the digital content file includes a photo captured during the first live performance.

5. The method of claim 1, further comprising:
receiving first metadata related to the first recorded data; and
receiving second metadata related to the second recorded data;
wherein the first metadata and second metadata each include one or more of data identifying the artist's name, date recorded, performance location, or live performance title.

6. The method of claim 1, wherein the first recorded data includes an audio/video recording and the method further comprises the step of:
processing the first recorded data with the computer server system to generate at least two formats of the audio/video recording.

7. The method of claim 6, wherein the at least two formats include two or more of a lossless compression audio-only version, a lossy compression audio-only version, a lossless compression/high definition (HD) audio/video version, or a lossy compression/standard definition (SD) audio/video version.

8. The method of claim 1, wherein the first recorded data is received in a compressed format and the method further comprises:
uncompressing the first recorded data; and
scanning song files within the uncompressed first recorded data to eliminate duplicates.

9. The method of claim 8, wherein the generating step comprises:
generating multiple formats of the song files after the elimination of duplicates; and
archiving the multiple formats.

10. A method for creating and archiving live performances, the method comprising:
generating a digital performance file corresponding to a live performance with a content provider computer system;
creating a digital archive with the content provider computer system including a first portion of the live performance and a second portion of the live performance by processing the digital performance file, the first and second portions each associated with metadata uniquely identifying the first and second portions; and
uploading the digital archive with the associated metadata from the content provider computer system to a computer server system via a network.

11. The method of claim 10, wherein the metadata includes one or more of data identifying the artist's name, date recorded, performance location, or live performance title.

12. The method of claim 10, wherein the creating step comprises:
creating a first sub archive including the first portion of the live performance and the second portion of the live performance in a first digital format;
creating a second sub archive including the first portion of the live performance and the second portion of the live performance in a second digital format;
creating the digital archive from the first and second sub archives.

13. The method of claim 12, wherein the first digital format is different than the second digital format and the first and second digital formats are selected from a lossless compression audio-only version, a lossy compression audio-only version, a lossless compression/high definition (HD) audio/video version, or a lossy compression/standard definition (SD) audio/video version.

14. A method for uploading digital content related to a live performance to a computer server system, the method comprising:
generating a digital content file related to a live performance with a consumer computer system;
associating the digital content file with metadata using the consumer computer system, the metadata related to the live performance; and
uploading the digital content file with the associated metadata from the consumer computer system to a computer server system via a network.

15. The method of claim 14, wherein the metadata include one or more of data identifying the artist's name, date recorded, performance location, or live performance title.

16. The method of claim 14, wherein the digital content includes a photo captured during the live performance.

17. The method of claim 14, further comprising:
capturing positioning information and current time information with the consumer computer system.

18. The method of claim 17, further comprising:
generating artist/performance metadata from the captured positioning information and current time information.

19. The method of claim 17, wherein the positioning information is global positioning information (GPS) and/or cellular/Wi-Fi triangulation information.
